(19) United States
(12) Patent Application Publication
(10) Pub. No.: US 2024/0236860 A1
(43) Pub. Date: Jul. 11, 2024

(54) CONTROL FOR USER QUALITY OF EXPERIENCE FOR INTELLIGENT WI-FI AND ADAPTIVE TARGET WAKE TIME OPERATIONS

(71) Applicant: Samsung Electronics Co., Ltd., Suwon-si (KR)

(72) Inventors: Khuong N. Nguyen, Frisco, TX (US); Abhishek Sehgal, Frisco, TX (US); Hao Chen, Allen, TX (US); Guanbo Chen, McKinney, TX (US)

(21) Appl. No.: 18/493,724

(22) Filed: Oct. 24, 2023

Related U.S. Application Data
(60) Provisional application No. 63/437,280, filed on Jan. 5, 2023.

(51) Int. Cl. H04W 52/02

(52) U.S. Cl. CPC H04W 52/0248

(57) ABSTRACT

Embodiments of the present disclosure provide methods and apparatuses for predicting a quality of experience (QoE) of a user and adjusting target wake time (TWT) operations for the user based on the predicted quality of experience in a wireless local area network communications system. The apparatuses include a communication device comprising a transceiver and a processor operably connected to the transceiver. The transceiver is configured to receive traffic over a wireless network for an application in a TWT operation. The processor is configured to determine network statistics from the traffic, estimate a QoE value for the application based on the network statistics, and determine new TWT parameters for the TWT operation based on the estimated QoE value.

### CROSS-REFERENCE TO RELATED APPLICATION AND CLAIM OF PRIORITY

This application claims priority under 35 U.S.C. § 119(e) to U.S. Provisional Patent Application No. 63/437,280 filed on Jan. 5, 2023, which is hereby incorporated by reference in its entirety.

### TECHNICAL FIELD

This disclosure relates generally to power management in wireless communications systems. Embodiments of this disclosure relate to methods and apparatuses for predicting a quality of experience of a user and adjusting target wake time operations for the user based on predicted quality of experience in a wireless local area network communications system.

### BACKGROUND

With the standardization process of the next generation IEEE 802.11 wireless local area network (WLAN), i.e., IEEE 802.11ax amendment entering the final stage, the IEEE 802.11ax amendment is drawing attention of the information technology (IT) industry. It newly introduces features for improving peak throughput and efficiency in an environment crowded by many 802.11 devices. Example environments include airports, stadiums, and so on. WI-FI alliance (WFA) has already launched the WI-FI 6 certification program for guaranteeing interoperability between certified products implementing IEEE 802.11ax amendment. In the market, device manufacturers are already starting to release WI-FI 6 certified smart mobile devices.

Target Wake Time (TWT) is one of the important features of the IEEE 802.11ax amendment. TWT enables wake time negotiation between an access point (AP) and an associated station (STA) for improving power efficiency. The wake time negotiation gives rise to TWT sessions (e.g., consecutive TWT sessions), where the STA wakes up at pre-negotiated times and for specified durations of time to communicate with the AP (e.g., via UL and/or DL communications). The IEEE 802.11ax amendment allows for periodic awakening, non-periodic awakening, and at-will awakening by the STA. In IEEE 802.11ax standards, two types of TWT operation are possible—individual TWT operation and broadcast TWT operation. Individual TWT agreements can be established between two STAs or between a STA and an AP. On the other hand, with broadcast TWT operation, an AP can set up a shared TWT session for a group of STAs.

TWT functionality can help save device power by setting a specific STA wakeup interval and wakeup service period (SP), which can reduce the time that the STA is awake with no data exchange between the AP and STA (thereby reducing power consumption). How to use this TWT functionality is still left for vendors to devise. The negotiated parameters such as the wake interval, wake duration, and initial wake time (offset) highly affect latency, throughput, as well as power efficiency, which are directly related to QoS (quality of service) or customer experience, as measured by quality of experience (QoE). Services with different traffic characteristics will have different TWT parameter configurations for better QoS or QoE. Additionally, the TWT configuration should adapt to network and service status variation.

### SUMMARY

Embodiments of the present disclosure provide methods and apparatuses for facilitating prediction of a QoE of a user and adjusting TWT operations for the user's device based on the predicted QoE in a wireless network (e.g., a WLAN).

In one embodiment, a communication device is provided. The communication device comprises a transceiver and a processor operably connected to the processor. The transceiver is configured to receive traffic over a wireless network for an application in a TWT operation. The processor is configured to determine network statistics from the traffic, estimate a QoE value for the application based on the network statistics, and determine new TWT parameters for the TWT operation based on the estimated QoE value.

In another embodiment, a method for communication is provided. The method comprises the steps of receiving traffic over a wireless network for an application in a TWT operation, determining network statistics from the traffic, estimating a QoE value for the application based on the network statistics, and determining new TWT parameters for the TWT operation based on the estimated QoE value.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates a diagram of packet exchange between devices according to embodiments of the present disclosure;

FIG. 4 illustrates an example TWT parameter set field of a TWT Request frame used for TWT parameter negotiation according to embodiments of the present disclosure;

FIG. 5 illustrates an example of individual TWT negotiation and operation according to embodiments of the present disclosure;

FIG. 6 illustrates an example format of a TWT element included in a TWT Request frame according to embodiments of the present disclosure;

FIG. 7 illustrates an example system for estimation of a user QoE and configuration of TWT parameters based on the estimated QoE according to embodiments of the present disclosure;

FIG. 8 illustrates an example QoE prediction system according to embodiments of the present disclosure;

FIG. 9 illustrates an example of using images collected from the source and from the recipient device to calculate MS-SSIM values according to embodiments of the present disclosure;

FIG. 10 illustrates an example of input formulation for a QoE prediction ML model according to embodiments of the present disclosure;

FIG. 11 illustrates an example Recurrent Neural Network (RNN) used as a QoE predictor according to embodiments of the present disclosure;

FIG. 12 illustrates an example 1D Convolutional Neural Network (CNN) used as a QoE predictor according to embodiments of the present disclosure;

FIG. 13 illustrates an example of gradient-boosted trees used as a QoE predictor according to embodiments of the present disclosure;

FIG. 14 illustrates an example operation of a post processor functioning as a running average calculator according to embodiments of the present disclosure;

FIG. 15 illustrates an example operation of a post processor functioning as a majority voting scheme according to embodiments of the present disclosure;

FIG. 16 illustrates an example operation of a post processor functioning as a weighted voting scheme according to embodiments of the present disclosure; and

FIG. 17 illustrates an example process for predicting a QoE of a user and adjusting TWT operations for the user based on the predicted QoE according to various embodiments of the present disclosure.

### DETAILED DESCRIPTION

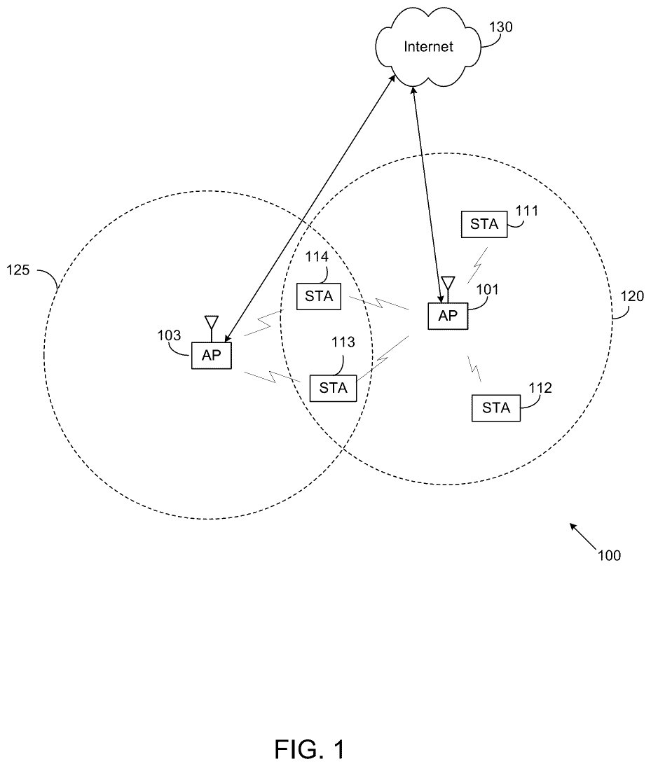

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that network communication (Wi-Fi, cellular, and the like) has become a fundamental technology in everyday life, with uses ranging from work to entertainment. Reliable wireless communication is needed to assist these activities. Ensuring QoE/QoS for users is almost a must-do to maintain a reliable wireless connection. However, ensuring QoE while simultaneously limiting power consumption is still a challenging problem.

To that end, embodiments of the present disclosure recognize that there are some cases in which existing methods for TWT operations are sub-optimal, as they do not take into account the current user QoE when setting TWT parameters. The ability to predict the current QoE that the user is experiencing in an application would enable appropriate configuration of the TWT parameters to ensure more optimal TWT operations. Additionally, the ability to predict QoE for mobile applications, especially applications that have very strict latency requirements—such as video calling or mobile gaming, would allow improvement upon a wide range of network applications such as traffic prioritization, controlling 802.11ax Target Wake Time functions, ensuring quality of service, network anomaly detection, and the like.

Accordingly, embodiments of the present disclosure provide apparatuses and methods that can predict the QoE experienced by a user based purely on network traffic information from the user device. For example, methods of the present disclosure obtain network statistic features based on network traffic (on the network layer, data link layer, or both) received by a mobile device in a time window and apply a machine learning (ML) model (also referred to as an artificial intelligence (AI) model) to predict a user QoE based on the network statistic features. Using the predicted QoE information, TWT operations can be designed to optimize TWT power saving, improving the overall efficiency of the network and extending the mobile device battery life. The network and data link layer statistic features used by the QoE predictor include one or more of the following: Traffic information (e.g., packet count, average packet size), packet timing information (e.g., interval-packet arrival time) in each time window to detect the current network service types, server and gateway packet loss, server and gateway round trip time (RTT), WI-FI Received Signal Strength Indicator (RSSI), transmitting & receiving speed, and clear channel assessment over radio-on ratio.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating prediction of a QoE of a user and adjusting TWT operations for the user's device based on the predicted QoE in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

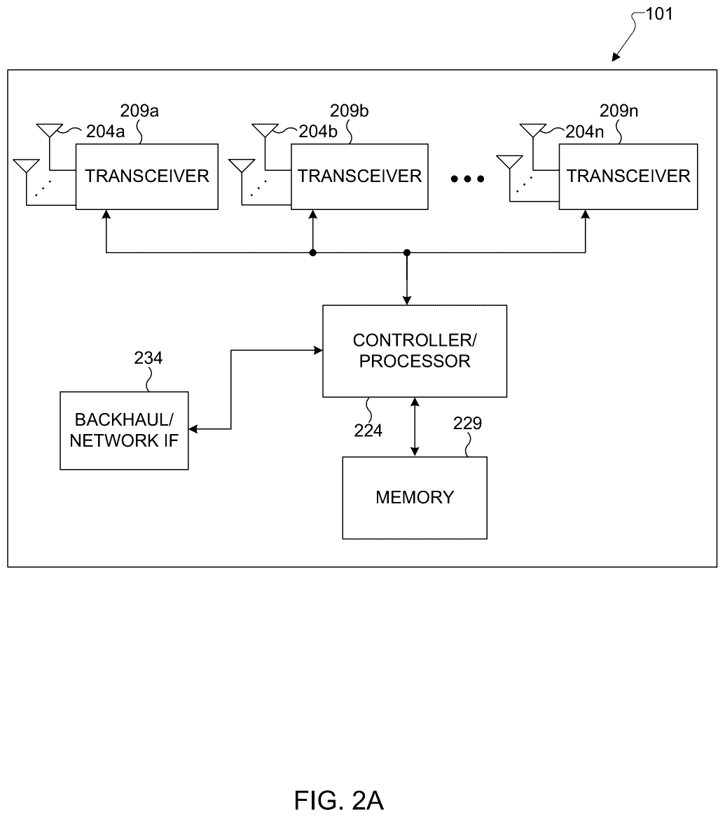

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating prediction of a QoE of a user and adjusting TWT operations for the user's device based on the predicted QoE in a WLAN. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating prediction of a QoE of a user and adjusting TWT operations for the user's device based on the predicted QoE in WLANs. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna (or antennas) 205, a radio frequency (RF) transceiver (or transceivers) 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate prediction of a QoE of a user and adjusting TWT operations for the user's device based on the predicted QoE in WLANs. In some embodiments, the controller/processor 240 includes at least one microprocessor or microcontroller.

The controller/processor 240 is also capable of executing other processes and programs resident in the memory 260, such as operations for facilitating prediction of a QoE of a user and adjusting TWT operations for the user's device based on the predicted QoE in WLANs. The controller/processor 240 can move data into or out of the memory 260 as required by an executing process. In some embodiments, the controller/processor 240 is configured to execute a plurality of applications 262, such as applications for facilitating prediction of a QoE of a user and adjusting TWT operations for the user's device based on the predicted QoE. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

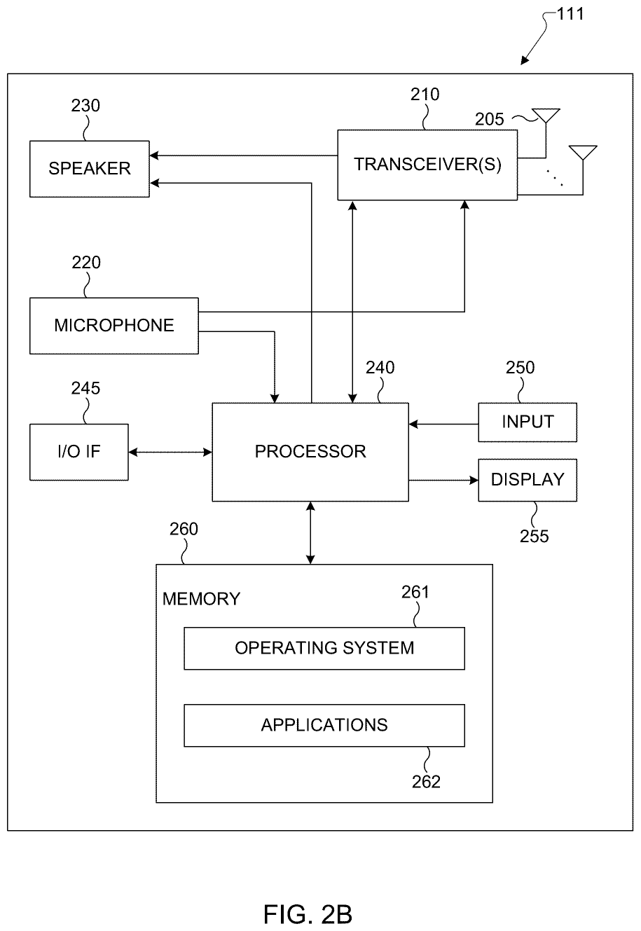

FIG. 3 illustrates a diagram of packet exchange between devices according to embodiments of the present disclosure. For the purposes of this disclosure, the figures will be discussed from the point of view of a STA, which may be a STA 111, but it is understood that it could be any suitable wireless communication device.

FIG. 3 illustrates two scenarios of exchange of uplink (UL) communication packets and downlink (DL) communication packets (which may be collectively referred to as traffic) between an AP and an associated client STA. First, without wake time negotiation between the AP and the STA (e.g., as seen in the top graph 302), and second, with wake time negotiation between the AP and the STA (e.g., in an IEEE 802.11ax system and as seen in the bottom graph 304). In the top graph 302, there is a regular stream of non-buffered traffic between the AP and the STA, with UL packets being interspersed with DL packets. In this scenario (i.e., without wake time negotiation) there is no option for the STA to enter a doze state or a power save state.

By contrast, in the bottom graph 304, wake time negotiation gives rise to consecutive TWT sessions 306. Each TWT session 306 is defined as the time period from the beginning of a TWT interval 308 to the end of the TWT interval 308. Each TWT session 306 includes two states: an active state 311, defined by a TWT service period (SP) duration 310 (during which the STA is awake to communicate with the AP), and a power save state or doze state 312 (during which the STA is not actively awake or communicating with the AP). As a result of wake time negotiation, power efficiency at the STA is improved without adding too much latency or allowing UL or DL packets to be dropped.

In wake time negotiation, the negotiated TWT parameters include the wake interval (e.g., the TWT interval 308 for each TWT session 306), wake duration (e.g., the TWT SP duration 310 for each TWT session 306), and initial wake time or offset (e.g., indicated by the TWT start time 314). These negotiated parameters highly affect latency, throughput, and power efficiency, which are directly related to the QoS (quality of service) a customer experiences, and QoE (quality of experience) of the customer. Services with different traffic characteristics can have different TWT parameter configurations for better QoS. Additionally, the TWT configuration should adapt to network and service status variation. In some embodiments, a TWT parameter set field is used to negotiate the TWT parameters.

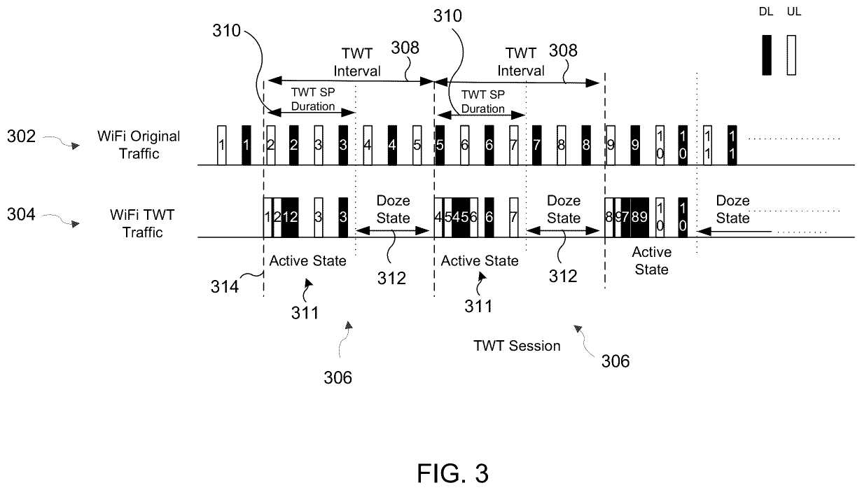

FIG. 4 illustrates an example TWT parameter set field 400 of a TWT Request frame used for TWT parameter negotiation according to embodiments of the present disclosure. The TWT agreement is initiated by a STA sending a TWT negotiation request to an AP. Once a TWT agreement is made between the AP and the STA, the STA periodically wakes up to communicate with the AP, where the interval between the successive wake times is jointly specified by the TWT wake interval mantissa 402 and TWT wake interval exponent 404 subfields in the TWT parameter set field 400.

The target wake time 406 and nominal minimum TWT wake duration 408 subfields specify, respectively, the first wake time for the TWT agreement, and the time for which the STA must wait before going to doze state when there is no transmitted traffic after a wake time, which is the TWT SP duration 310 in FIG. 3.

As discussed herein above, there are two types of TWT: broadcast TWT and individual TWT. In broadcast TWT, the AP sets up a shared TWT agreement for a group of STAs, and a Beacon is needed in broadcast TWT. Individual TWT, which is different from broadcast TWT, is initiated by the STA. The STA sends the TWT negotiation request to the AP, while the AP responds to the request. This process is referred to as TWT negotiation. Eventually the STA and AP make an agreement (referred to as a TWT agreement) on the TWT parameters, and up to 8 TWT agreements are supported simultaneously.

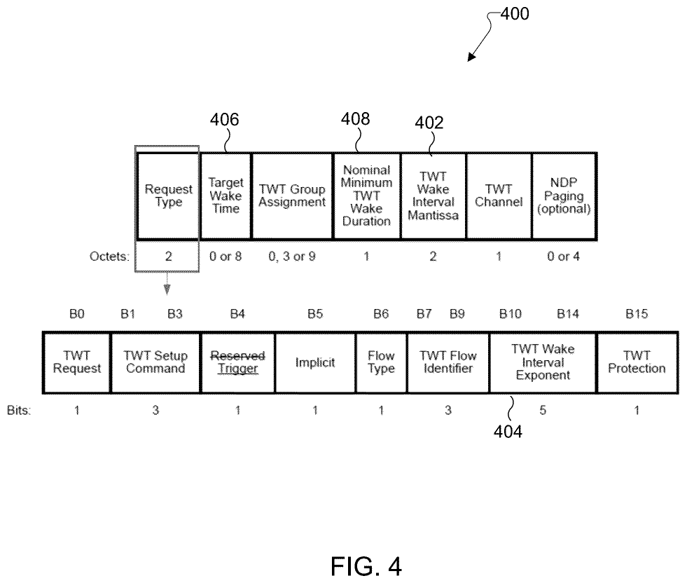

FIG. 5 illustrates an example of individual TWT negotiation and operation 500 according to embodiments of the present disclosure.

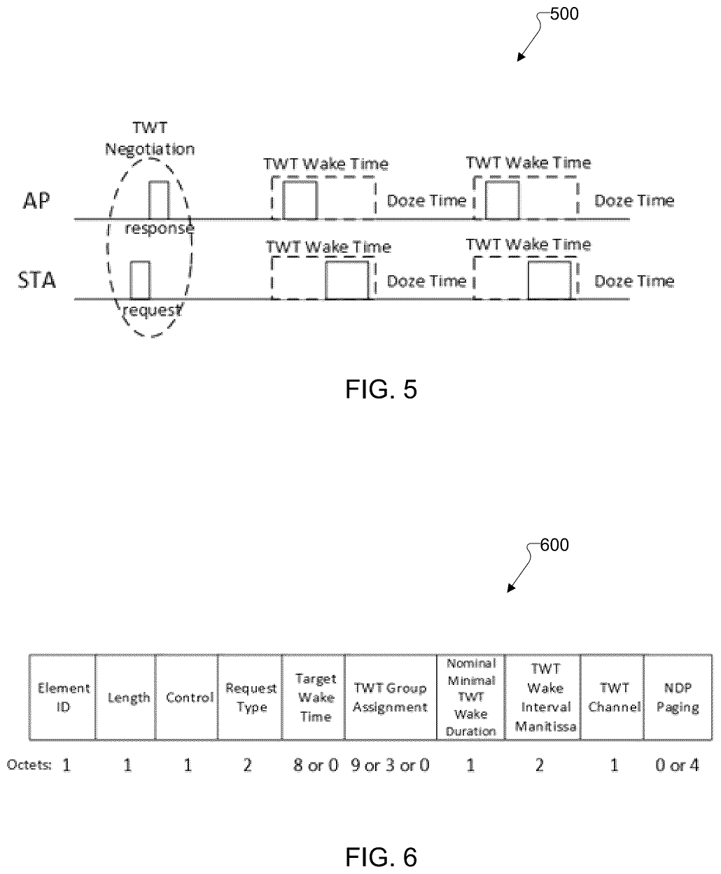

FIG. 6 illustrates an example format 600 of a TWT element included in a TWT Request frame according to embodiments of the present disclosure. The TWT element includes a TWT parameter set, such as TWT parameter set 400. Two key parameters control the duty cycle of the 802.11ax link under TWT operation: the TWT Wake Interval and the Minimal TWT Wake Duration. The TWT Wake Interval represents the wake-up time interval between two consecutive TWT sessions. The value is defined by the TWT Wake Interval Mantissa field in the TWT element. Ideally it should be greater than 0, but in practice it normally has a minimal value, e.g., 10 ms. The Minimal TWT Wake Duration represents the minimal duration that a STA shall stay awake after the start time of the TWT SP. During this time the STA is able to receive/transmit data frames from/to the AP or other STAs.

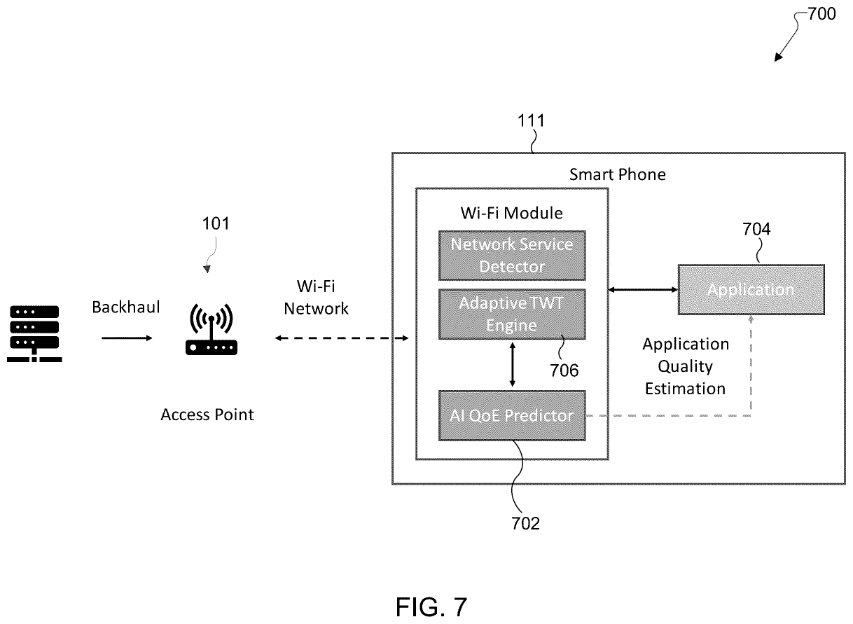

FIG. 7 illustrates an example system 700 for estimation of a user QoE and configuration of TWT parameters based on the estimated QoE according to embodiments of the present disclosure. The smart phone of system 700 functions as a STA 111 connected to an AP 101, and it is understood that any suitable WI-FI STA device could be used instead of a smart phone. The smart phone includes a QoE predictor 702 that can apply approaches for predicting how a user perceives the quality of an experience (i.e., QoE) provided by a mobile application 704 under TWT operation using features extracted from the network link layer statistics. The smart phone uses the predicted QoE to update the TWT parameters to optimize the TWT operation (via the adaptive TWT engine 706).

The type of application that is used to describe the solution in this disclosure may be, for example, a video calling application, but the solution is not limited to video calling applications. Additionally, this solution focuses on TWT power saving mechanisms, but the estimated QoE can be used for other purposes such as traffic prioritization, ensuring quality of service, network anomaly detection, and the like.

The QoE prediction mechanism (e.g., the QoE predictor 702) does not require access to the application layer or physical layer information but relies solely on the network statistics features to make an estimation. As noted above, QoE information is very useful in designing TWT operations so that TWT parameters such as wake interval and wake duration can be adaptively adjusted to optimally conserve power in the corresponding scenarios.

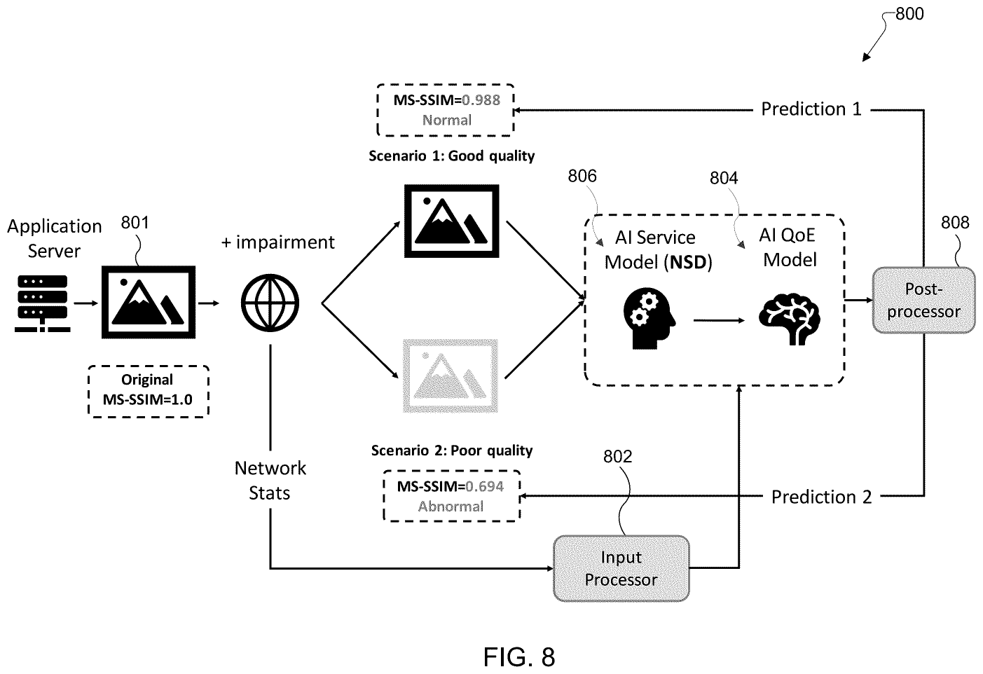

FIG. 8 illustrates an example QoE prediction system 800 according to embodiments of the present disclosure. The QoE prediction system 800 may correspond to the QoE predictor 702 of FIG. 7. The QoE prediction system 800 comprises 2 major components: the input processor 802 and the machine learning (ML)-based QoE predictor 804. The ML-based QoE predictor 804 may alternatively be referred to as an AI QoE predictor or model.

In the example of FIG. 8, content 801 (in this case, an image) for an application or service under TWT operation is sent to the device (e.g., the STA 111) over the Wi-Fi network, which adds some impairment to the content 801. Network statistic features from the network traffic containing the content 801 are extracted and passed to the input processor 802. The input processor 802 is in charge of converting traffic statistic features to the appropriate form for the AI service model 806 and the AI QoE predictor 804. The job of the AI service model 806 is to detect if the service is real-time—e.g., whether the running application for which QoE is evaluated is a video call, mobile game, or the like. If so, then the AI QoE predictor 804 is activated.

Next, the AI QoE predictor 804 uses the input from the input processor 802 to make a QoE prediction (or estimation) for the application. Finally, the post processor 808 receives the output from the AI QoE predictor 804 as its input and produces a final decision in the form of a QoE estimate. The post processor 808 may, for example, consider a moving window of QoE estimates from the QoE predictor 804 and perform an operation to smooth over anomalous results. This decision will then be used to configure the TWT parameters in order to optimize the power consumption of the application.

Embodiments of the present disclosure for estimating an application QoE may be generally divided into two approaches. The first approach is estimating the application Quality of Service (QOS)—i.e., Packet Loss, Delay, and Jitter experienced by the application—and then mapping those estimated QoS values to a user QoE value. The second approach is estimating a user QoE value directly from the network statistics using an ML model.

For the first approach, a QoS to QoE mapping function is created based on ground truths that are collected from application layer statistics for an application that is receiving content over the network. In particular, the Delay, Jitter, and Packet Loss values experienced by the application are collected along with the network layer statistics for the purposes of creating mapping functions from network statistics to estimated application QoS. For example, the following functions f, g, and h represent mapping functions created to map the features of the network statistics to the QoS values of Delay, Jitter, and Packet Loss:

$$Delay = f ( Network Features )$$

$$Jitter = g ( Network Features )$$

$$Packet Loss = h ( Network Features )$$

The estimated application QoS values can then be used alongside a ground truth of QoE values for the content experienced by the user of the application while the network statistics were gathered to create a mapping function from estimated application QoS to estimated application QoE. As Delay and Jitter are responsible for changes in resolution of real time video content, and Packet Loss results in frame drops, it is possible to create a mapping function that can estimate the QoE based on these network QoS values. For example, the following function F represents a mapping function created to map the QoS values to a QoE value:

$$QoE = F ( Delay , Jitter , Packet Loss )$$

For the second approach, in order to create ground truths for the purpose of training a machine learning model that can predict the application QoE, a numerically quantifiable value can be assigned to represent the quality of a piece of content. In the embodiments provided below, the multi-scale structural similarity index measure (MS-SSIM) algorithm is used to provide a metric for image content quality, however it is understood that alternative metrics for assessing image quality (e.g., SSIM, visual information fidelity (VIF or VIFP), peak signal-to-noise ratio (PSNR)) could be used.

MS-SSIM is a full reference image quality assessment algorithm that is designed to measure the similarity between two images, with the goal of determining how much quality is lost in the process of transforming one image into the other. MS-SSIM is based on the idea that human perception of image quality is influenced by both local and global features in the image. It therefore looks at the image at multiple scales, or resolutions, in order to capture both local and global structures. This allows it to provide a more comprehensive and accurate assessment of image quality compared to methods that only consider local or global features. MS-SSIM values range from 0 to 1.0.

Accordingly, in order to generate ground truths for use in training an ML model for QoE prediction in the form of MS-SSIM values for an application streaming image content over a WI-FI network, the image content is collected on both the receiving device side and the transmitting source side during streaming. The source images are known to be optimal quality (i.e., MS-SSIM=1.0), while the received images will have quality impaired by the network (i.e., MS-SSIM<1.0).

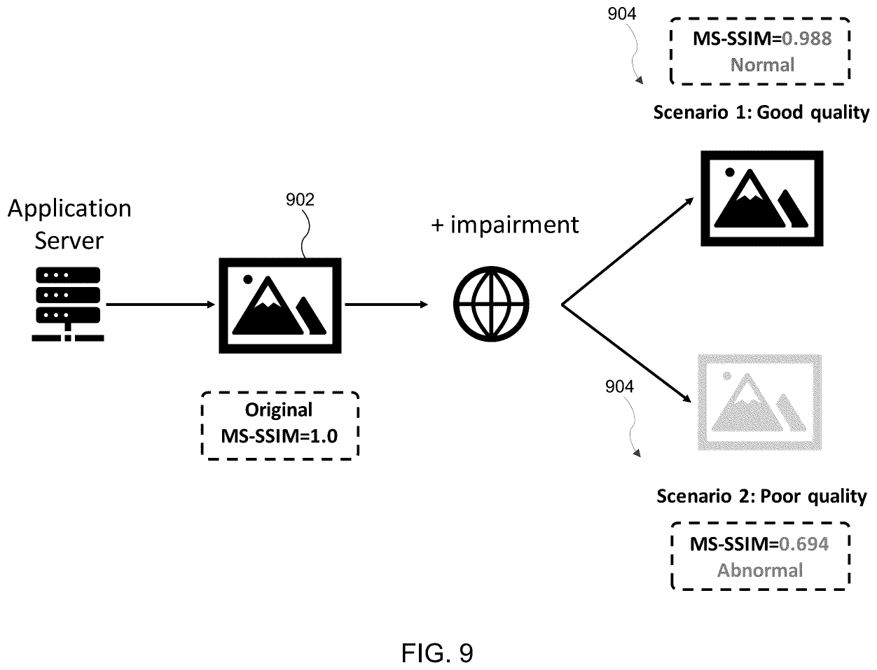

FIG. 9 illustrates an example of using images collected from the source and from the recipient device to calculate MS-SSIM values according to embodiments of the present disclosure. With the original source image 902, the MS-SSIM values for a corresponding received image 904 can be calculated. FIG. 9 illustrates alternative cases in which the received image 904 is determined to be of good quality and poor quality based on its MS-SSIM value.

The MS-SSIM values of the received images may be used as training inputs to the ML model. At the same time, network statistics for the traffic containing the image content are collected and used as inputs to the ML model. The ML model can thereby be trained to predict QoE (in the form of an MS-SSIM value) as a function of network statistic features.

As discussed above, an input processor may be used to collect network layer statistics and data link layer statistics related to traffic for an application and format the statistics in an appropriate form for input to the QoE predictor (e.g., the ML model trained for QoE prediction).

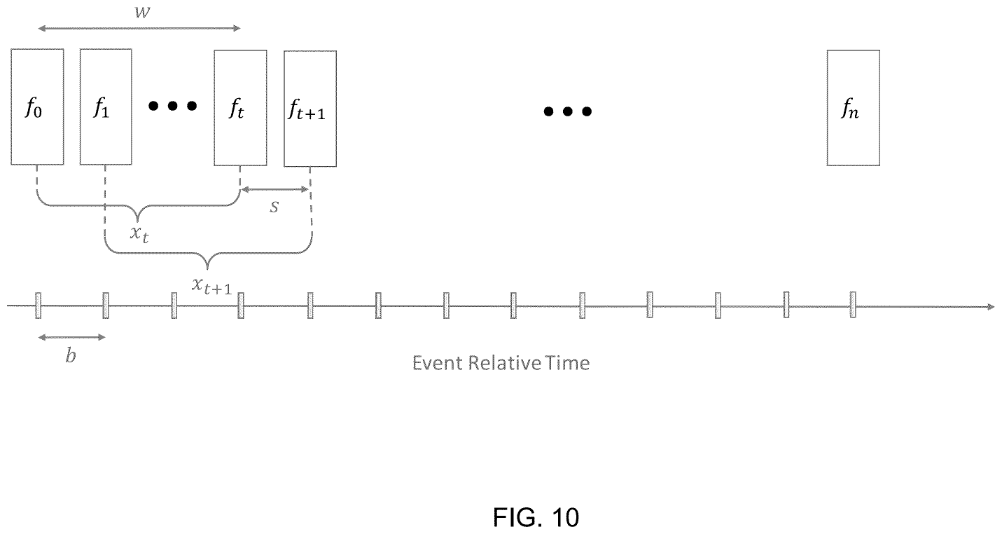

FIG. 10 illustrates an example of input formulation for a QoE prediction ML model according to embodiments of the present disclosure. In this example, the input processor calculates a set of features from the network traffic received within a period b, which is called a burst, and creates a feature vector f containing the set of features. These features are obtained based on packet information, packet timing information, and data link layer statistics, and can include, but are not limited to:
Uplink & downlink maximum inter-arrival time: the maximum time difference between arrival of one packet and the next packet within a burst (2 values).
Uplink & downlink average inter-arrival time: the average time difference between arrival of one packet and the next packet within a burst (2 values).
Uplink & downlink packet counts: The uplink and downlink number of packets within a burst (2 values).
Uplink & downlink minimum packet size: The uplink and downlink minimum packet size in Mb within a burst (2 values).
Uplink & downlink maximum packet size: The uplink and downlink maximum packet size in Mb within a burst (2 values).
Uplink & downlink average packet size: The uplink and downlink average packet size in Mb within a burst (2 values).
Uplink & downlink UDP packet counts: The uplink and downlink User Datagram Protocol number of packets within a burst (2 values).
Uplink & downlink TCP packet counts: The uplink and downlink Transmission Control Protocol number of packets within a burst (2 values).
Received Signal Strength Indicator (RSSI) (1 value)
Transmitting and receiving speed (2 values)
Transmitting and receiving success rate (2 values)
Clear channel assessment over radio on time ratio (2 values)

In this example, the input is formulated as follows: a sliding window of size w (in milliseconds) is moved with a stride or moving step of s time steps ts to form the input. Each time step ts has a duration of one burst b (in milliseconds) in this example. In some examples, the moving step of s and the time step (or burst) may both be 500 ms, although other values may be used. Furthermore, the moving step of s does not need to be equal to the time step ts.

At time t, the input xₜ consists of a combination of multiple feature vectors

$$[ {f}_{t - ( \frac{w}{ts} - 1 )} , … , {f}_{t} ] .$$

For example, using a window of 3 seconds (3,000 ms) with a time step of 500 ms, the total number of time steps for each input is

$$\frac{3000 ms}{500 ms} = 6.$$

Therefore, the input at time t, xₜ will be the following combination of feature vectors [fₜ₋₅, fₜ₋₄, fₜ₋₃, fₜ₋₂, fₜ₋₁, fₜ].

The ML-based QoE predictor can be implemented using different machine learning techniques to train an ML model to predict an application QoE value (e.g., an MS-SSIM value) directly from network statistics (e.g., the input from the input processor). In one approach, the ML model may be a regression model ranging from a decision tree to a neural network. Another approach to implement the ML-based QoE predictor is to frame the problem as a binary classification, which is an anomaly detection problem. In this case, an MS-SSIM value that is less than a certain threshold (for example, 0.876) shall be classified as an anomaly while any MS-SSIM value above the threshold is classified as normal. The ML model in such a case will be trained as a classifier to detect anomalous MS-SSIM values.

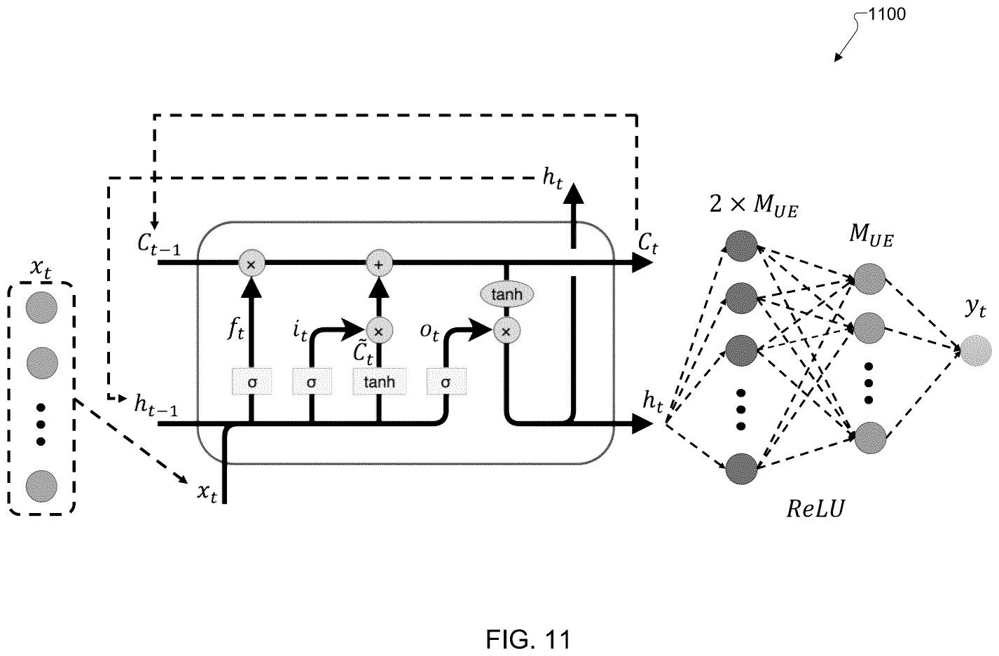

FIG. 11 illustrates an example Recurrent Neural Network (RNN) 1100 used as a QoE predictor according to embodiments of the present disclosure. In this example, the core of the RNN 1100 is a Long Short-Term Memory (LSTM) Unit. In other examples, a Gated Recurrent Unit (GRU) could be used instead of an LSTM.

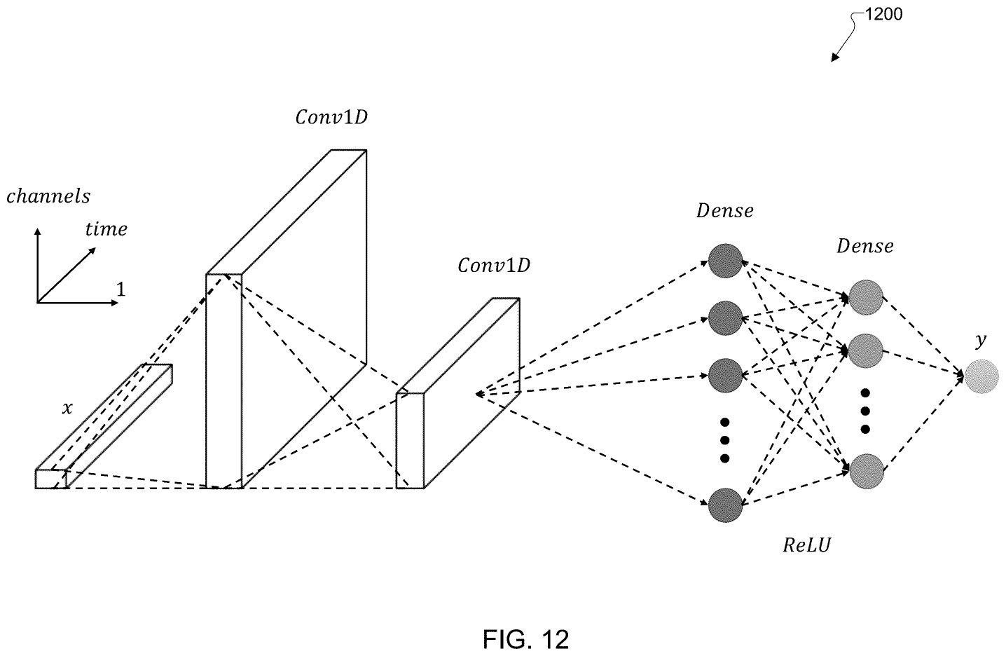

FIG. 12 illustrates an example 1D Convolutional Neural Network (CNN) 1200 used as a QoE predictor according to embodiments of the present disclosure. The idea is to use a convolutional layer to convolve along the time dimension. The model extracts features from sequences and maps the internal features of the sequence. It is effective for deriving features and analysis of signal data over a fixed-length period.

In general, if a neural network-based regression model (e.g., RNN, CNN, etc.) is used to implement the QoE predictor in the ML-based QoE predictor module, then the activation of the last layer of the neural network-based algorithm should be a sigmoid function to regulate the output to the range between 0 and 1.

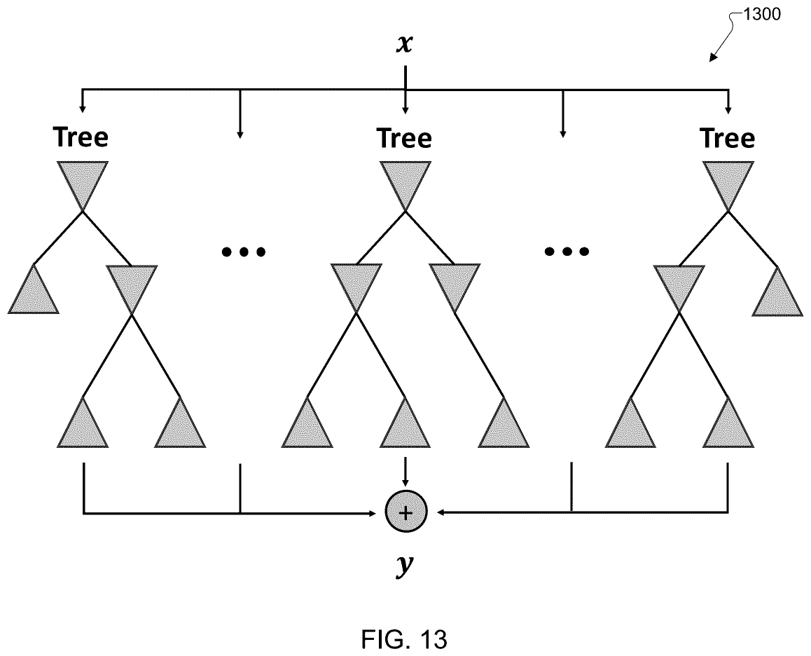

FIG. 13 illustrates an example of gradient-boosted trees 1300 used as a QoE predictor according to embodiments of the present disclosure. The tree structure is used as the base-learner, and the same features are used to train the gradient-boosted tree model (e.g., an XGBoost model) as would be used to train a neural network model.

As discussed above, the purpose of the post processor is to stabilize the output of the QoE predictor. The post processor shall store the most recent n past predictions produced by the QoE predictor and use this information to generate a final decision—n is empirically determined to work with the specific application but a default value of 5 may be used. The post processor has n buffer slots (in a FIFO buffer) corresponding to n time steps from the current time step to the n-th time step in the past.

When the QoE predictor is implemented as a regression model, the post processor is designed to simply function as a running average calculator. When the QoE predictor is implemented as a binary classifier, the post processor is designed to function as a voting system.

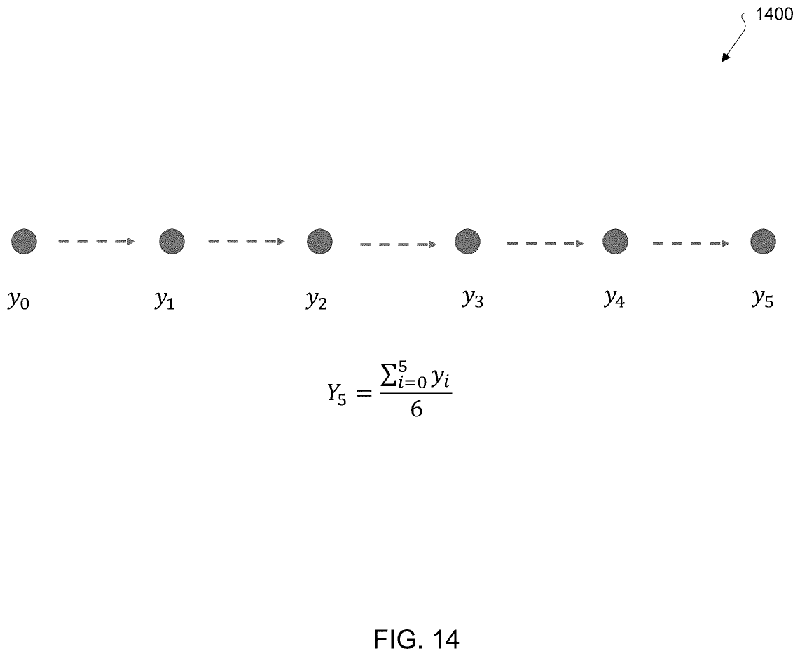

FIG. 14 illustrates an example operation 1400 of a post processor functioning as a running average calculator according to embodiments of the present disclosure. In this example, n=6 is used, and thus the 6 most recent outputs from a regression model QoE predictor are contained in the buffer. The outputs in the buffer are averaged to determine an output decision value Y.

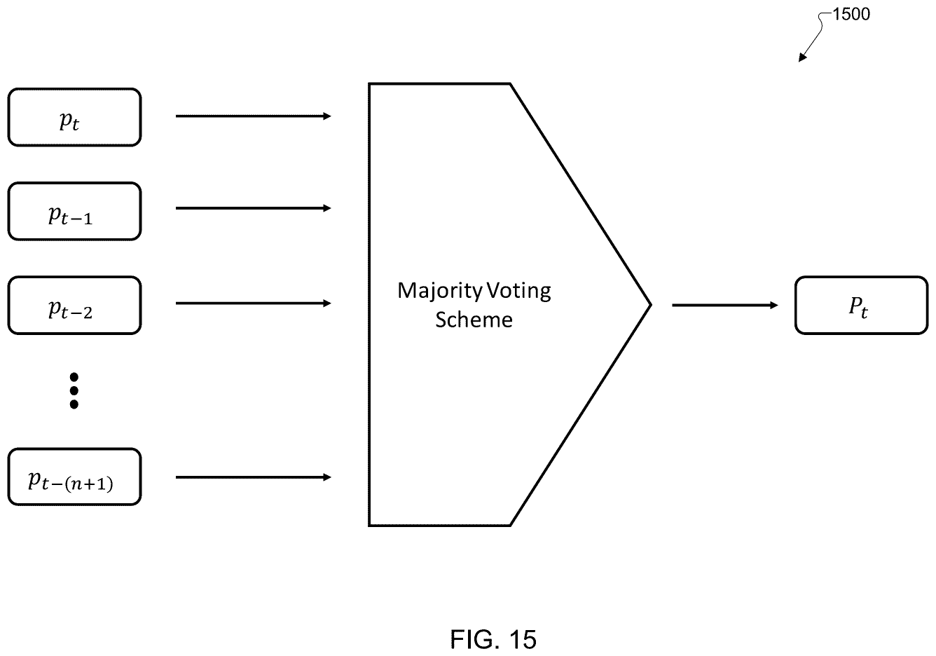

FIG. 15 illustrates an example operation 1500 of a post processor functioning as a majority voting scheme according to embodiments of the present disclosure. In this example the QoE predictor is a binary classifier, and each output p from the QoE predictor is one of two values: anomaly or normal (which could respectively be represented as 0 and 1, or vice versa). The post processor in operation 1500 counts the number of each class (normal and anomaly) presented in the buffer and determines a final output decision value P based on the majority class (i.e., the class which has more instances in the buffer).

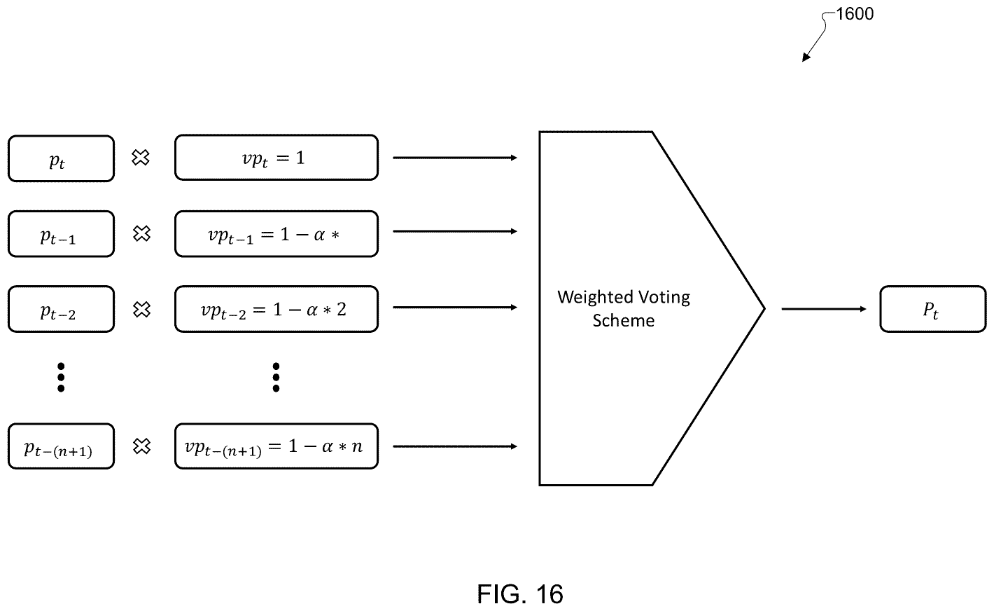

FIG. 16 illustrates an example operation 1600 of a post processor functioning as a weighted voting scheme according to embodiments of the present disclosure. This example is similar to that of FIG. 15, with the addition of weights assigned to each of the buffer entries. In this example, the most recent prediction will carry the largest weight and the oldest will carry the smallest weight. The class that has the largest value after performing the weighted sum will be used as the output decision value P.

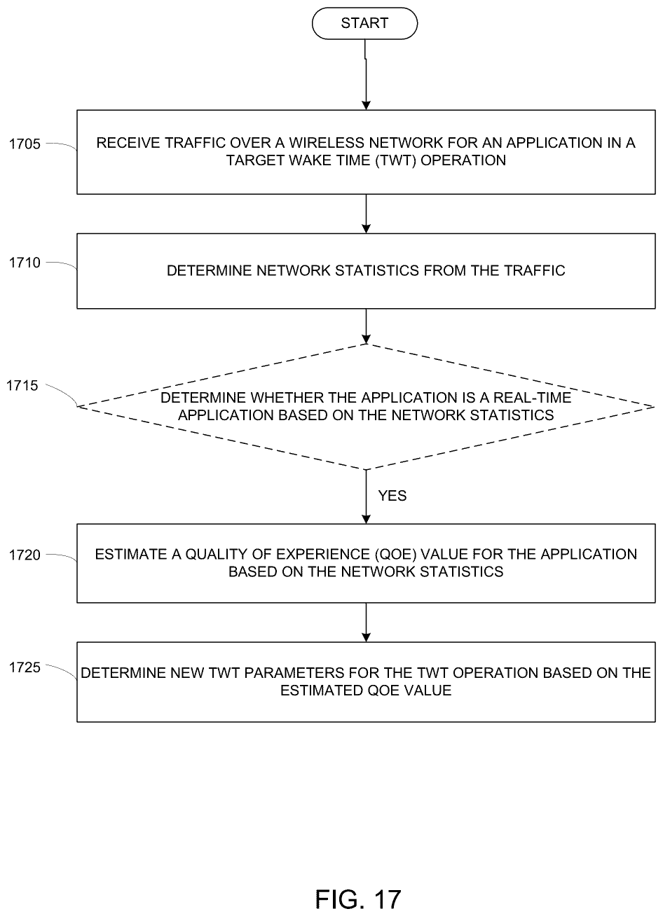

FIG. 17 illustrates an example process for predicting a QoE of a user and adjusting TWT operations for the user based on the predicted QoE according to various embodiments of the present disclosure. For convenience, the process of FIG. 17 is discussed as being performed by a communication device that is a WI-FI STA (e.g., STA 111), but it is understood that any other suitable wireless communication device. For ease of explanation, the process is assumed to be performed by the processor of the wireless communication device unless otherwise stated.

The process begins with the communication device receiving traffic over a wireless network for an application in a TWT operation (step 1705). The traffic includes content for the application, for example a series of images for a streaming video application.

Next, the communication device determines network statistics from the traffic (step 1710). The network statistics may be determined from features of the network link layer, data link layer, or both. The network statistics are not, however, determined from the application layer, and thus this process does not require access to application layer data.

In some embodiments, the communication device may determine whether the application is a real-time application based on the network statistics (step 1715). In such embodiments, if the application is not real-time, then the device may determine that it is unnecessary to optimize the TWT operations and may terminate the process as a result. If the application is determined to be real-time, however, then the process continues to step 1720. Alternatively, the device may skip step 1715 and always continue to step 1720.

The communication device then estimates a QoE value for the application based on the network statistics (step 1720). In some embodiments of step 1720, the communication device first estimates QoS values for the application as a function of the network statistics, and then estimates the QoE value for the application as a function of the estimated QoS values. For example, the device may estimate Delay, Jitter, and Packet Loss QoS values from the network statistics and then estimate a QoE value from these estimated QoS values (using, e.g., the mapping functions discussed herein above).

In other embodiments of step 1720, the communication device uses an ML (or AI) model to estimate (or predict) the QoE value from the network statistics. In such embodiments the ML model must first be trained (i.e., prior to step 1705). To do so, training traffic for the application is collected over the wireless network in a previous TWT operation and a set of training QoE values for the application is derived from copies of content included in the training traffic that have been impaired by transmission over the wireless network (i.e., received images) as well as an unimpaired copy of the content (i.e., the source image). A set of training network statistics is determined from the training traffic, and the ML model is trained, using the set of training network statistics as training features and the set of training QoE values as training outcomes, to predict outcome QoE values for the application from input network statistic features. If the content for the application is an image (e.g., a frame of a streaming video), then the training QoE values and the outcome QoE values may be MS-SSIM values.

In embodiments using such an ML model, the communication device at step 1720 estimates the QoE value for the application by inputting the network statistics to the trained ML model as network statistic features and obtaining predicted outcome QoE values as outputs from the trained ML model. The network statistic features in this case may be represented as a set of network statistic feature vectors, where each vector comprises statistic features determined from the network statistics at step 1710. For example, for each time period of a consecutive set of time periods the device may generate a network statistic feature vector from the network statistics that are determined from the traffic within that time period, and then combine these network statistic feature vectors from the consecutive set of time periods to form the set of network statistic feature vectors.

Finally, the communication device determines new TWT parameters for the TWT operation based on the estimated QoE value (step 1725). The new TWT parameters are preferably determined such that they will optimize power consumption and QoE (e.g., minimize power consumption while maintaining an acceptable level of QoE). The new TWT parameters can then be applied by TWT renegotiation.

In some embodiments using a trained ML model for the QoE estimation at step 1720, the ML model is a regression model and the predicted outcome QoE values are in a range between 0 and 1. In these embodiments, the communication device may then determine the new TWT parameters for the TWT operation at step 1725 based on an average (e.g., a running average) of a number of the most recently obtained predicted outcome QoE values.

In other embodiments using a trained ML model for the QoE estimation at step 1720, the ML model is a binary classification model and the predicted outcome QoE values are a binary indication of anomalous or not anomalous (representing, for example, “unacceptable” QoE and “acceptable” QoE, respectively). In these embodiments, the communication device may then determine the new TWT parameters for the TWT operation at step 1725 by applying a voting scheme to a number of the most recently obtained predicted outcome QoE values. The voting scheme may be a majority voting scheme, a weighted voting scheme, or the like.

The above flowchart illustrates example methods that can be implemented in accordance with the principles of the present disclosure and various changes could be made to the method illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A communication device comprising:
a transceiver configured to receive traffic over a wireless network for an application in a target wake time (TWT) operation; and
a processor operably coupled to the transceiver and configured to:
determine network statistics from the traffic,
estimate a quality of experience (QoE) value for the application based on the network statistics, and
determine new TWT parameters for the TWT operation based on the estimated QoE value.

2. The communication device of claim 1, wherein the processor is further configured to:
determine whether the application is a real-time application based on the network statistics, and
based on a determination that the application is a real-time application, perform the estimation of the QoE value for the application.

3. The communication device of claim 1, wherein the processor is further configured to:
estimate quality of service (QOS) values for the application as a function of the network statistics; and
estimate the QoE value for the application as a function of the estimated QoS values.

4. The communication device of claim 3, wherein the estimated QoS values of the application include at least one of delay, jitter, or packet loss.

5. The communication device of claim 1, wherein:
prior to the traffic being received by the transceiver, training traffic for the application is collected over the wireless network in a previous TWT operation,
a set of training QoE values for the application is derived from:
copies of content included in the training traffic that have been impaired by transmission over the wireless network; and
an unimpaired copy of the content,
a set of training network statistics is determined from the training traffic, and
a machine learning (ML) model is trained, using the set of training network statistics as training features and the set of training QoE values as training outcomes, to predict outcome QoE values for the application from network statistic features.

6. The communication device of claim 5, wherein:
the content is an image, and
the training QoE values and the outcome QoE values are multi-scale structural similarity index measure (MS-SSIM) values.

7. The communication device of claim 5, wherein the processor is configured to estimate the QoE value for the application by inputting the network statistics to the trained ML model as network statistic features and obtaining predicted outcome QoE values from the trained ML model.

8. The communication device of claim 7, wherein:
the network statistic features are a set of network statistic feature vectors, and
the processor is further configured to:
generate a network statistic feature vector from the network statistics that are determined from the traffic within a time period, for each time period of a consecutive set of time periods; and
combine the network statistic feature vectors from the consecutive set of time periods to form the set of network statistic feature vectors.

9. The communication device of claim 7, wherein:
the trained ML model is a regression model,
the predicted outcome QoE values are in a range between 0 and 1, and
the processor is further configured to determine the new TWT parameters for the TWT operation based on an average of a number of the most recently obtained predicted outcome QoE values.

10. The communication device of claim 7, wherein:
the trained ML model is a binary classification model,
the predicted outcome QoE values are a binary indication of anomalous or not anomalous, and
the processor is further configured to determine the new TWT parameters for the TWT operation by applying a voting scheme to a number of the most recently obtained predicted outcome QoE values.

11. A method for communication comprising:
receiving traffic over a wireless network for an application in a target wake time (TWT) operation;
determining network statistics from the traffic;
estimating a quality of experience (QoE) value for the application based on the network statistics; and
determining new TWT parameters for the TWT operation based on the estimated QoE value.

12. The method of claim 11, further comprising:
determining whether the application is a real-time application based on the network statistics; and
based on a determination that the application is a real-time application, performing the estimation of the QoE value for the application.

13. The method of claim 11, further comprising:
estimating quality of service (QOS) values for the application as a function of the network statistics; and
estimating the QoE value for the application as a function of the estimated QoS values.

14. The method of claim 13, wherein the estimated QoS values of the application include at least one of delay, jitter, or packet loss.

15. The method of claim 11, wherein:
prior to the traffic being received, training traffic for the application is collected over the wireless network in a previous TWT operation,
a set of training QoE values for the application is derived from:
copies of content included in the training traffic that have been impaired by transmission over the wireless network; and
an unimpaired copy of the content,
a set of training network statistics is determined from the training traffic, and
a machine learning (ML) model is trained, using the set of training network statistics as training features and the set of training QoE values as training outcomes, to predict outcome QoE values for the application from network statistic features.

16. The method of claim 15, wherein:
the content is an image, and
the training QoE values and the outcome QoE values are multi-scale structural similarity index measure (MS-SSIM) values.

17. The method of claim 15, further comprising estimating the QoE value for the application by inputting the network statistics to the trained ML model as network statistic features and obtaining predicted outcome QoE values from the trained ML model.

18. The method of claim 17, wherein:
the network statistic features are a set of network statistic feature vectors, and
the method further comprises:
generating a network statistic feature vector from the network statistics that are determined from the traffic within a time period, for each time period of a consecutive set of time periods; and
combining the network statistic feature vectors from the consecutive set of time periods to form the set of network statistic feature vectors.

19. The method of claim 17, wherein:
the trained ML model is a regression model,
the predicted outcome QoE values are in a range between 0 and 1, and
the method further comprises determining the new TWT parameters for the TWT operation based on an average of a number of the most recently obtained predicted outcome QoE values.

20. The method of claim 17, wherein:
the trained ML model is a binary classification model,
the predicted outcome QoE values are a binary indication of anomalous or not anomalous, and
the method further comprises determining the new TWT parameters for the TWT operation by applying a voting scheme to a number of the most recently obtained predicted outcome QoE values.
